(19) United States
(12) Patent Application Publication
(10) Pub. No.: US 2023/0129939 A1
(43) Pub. Date: Apr. 27, 2023

(54) REMINDER AND ESCALATION IN A WORKFLOW

(71) Applicant: ADP, Inc., Roseland, NJ (US)

(72) Inventors: Abhishek Prasad, Pune (IN); Yandapalle Nikhil Kumar Reddy, Hyderabad (IN); Gaurav Agarwal, Jaipur (IN); Niranjan Tare, Pune (IN); Ananta Bose, Hyderabad (IN); Vinay Kanth Nadikuda, Hyderabad (IN)

(21) Appl. No.: 17/452,015

(22) Filed: Oct. 22, 2021

(51) Int. Cl. G06Q 10/06

(52) U.S. Cl. CPC G06Q 10/0633

(57) ABSTRACT

A method, apparatus, system, and computer program code provide a graphical user interface for reminder and escalation in a workflow. In a first page of the graphical user interface, a computer system receives configurations of reminders and escalations for a set of milestones in a workflow. In a second page of the graphical user interface, the computer system displays a separate timeline for each milestone. Each timeline spans from a start date to a completion deadline for a respective milestone. In the second page of the graphical user interface, the computer system displays a number of reminder dates along each timeline, according to a respective configuration. The computer system monitors a completion status for a milestone. Upon a reminder date, the computer system sends a notification if the milestone is not complete. Upon an escalation date, the computer system sends notifications periodically until the milestone is complete.

### BACKGROUND

### 1. Field

The disclosure relates generally to an improved computer system and, more specifically, to a method, apparatus, computer system, and computer program product for reminder and escalation in a workflow.

### 2. Description of the Related Art

Generally, workflows are computer-implemented representations of a real-world sequence of industrial, administrative, or other processes a business operation passes from initiation to completion. Workflows assist users with collaboration on documents and management of project tasks by implementing specific business processes on documents and items. Among other cases, workflows also assist organizations with adherence to consistent business processes, and improve organizational efficiency and productivity by managing the tasks and steps involved in specific business processes.

A workflow may include one or more milestones. Each milestone represents a step or stage in the workflow process. Often, earlier milestones in the workflow must be completed in sequence before work on a subsequent milestone can commence.

### SUMMARY

According to one embodiment of the present invention, a method in a graphical user interface provides for reminder and escalation in a workflow. In a first page of the graphical user interface, a computer system receives configurations of reminders and escalations for a set of milestones in a workflow. In a second page of the graphical user interface, the computer system displays a separate timeline for each milestone. Each timeline spans from a start date to a completion deadline for a respective milestone. In the second page of the graphical user interface, the computer system displays a number of reminder dates along each timeline, according to a respective configuration. The computer system monitors a completion status for a milestone. Upon a reminder date, the computer system sends a notification if the milestone is not complete. Upon an escalation date, the computer system sends notifications periodically until the milestone is complete.

According to another embodiment of the present invention, a computer system comprises a hardware processor, a workflow manager in communication with the hardware processor, and a display system having a graphical user interface displayed thereon. In a first page of the graphical user interface, the workflow manager receives configurations of reminders and escalations for a set of milestones in a workflow. In a second page of the graphical user interface, the workflow manager displays a separate timeline for each milestone. Each timeline spans from a start date to a completion deadline for a respective milestone. In the second page of the graphical user interface, the workflow manager system displays a number of reminder dates along each timeline, according to a respective configuration. The workflow manager monitors a completion status for a milestone. Upon a reminder date, the workflow manager sends a notification if the milestone is not complete. Upon an escalation date, the workflow manager sends notifications periodically until the milestone is complete.

According to yet another embodiment of the present invention, a computer program product comprises a computer-readable storage media with program code stored on the computer-readable storage media for reminder and escalation in a workflow. The program code is executable by a computer system: to receive, in a first page of the graphical user interface, configurations of reminders and escalations for a set of milestones in a workflow; to display, in a second page of the graphical user interface, a separate timeline for each milestone, where in each timeline spans from a start date to a completion deadline for a respective milestone; to display, in the second page of the graphical user interface, the number of reminder dates along each timeline, according to a respective configuration; and to monitor a completion status for a milestone, including sending a notification if the milestone is not complete upon a reminder date, and upon an escalation date, sending notifications periodically until the milestone is complete.

### BRIEF DESCRIPTION OF THE DRAWINGS

FIG. 1 is a pictorial representation of a network of data processing systems in which illustrative embodiments may be implemented;

FIG. 2 is a block diagram of an [CLAIM PREAMBLE] environment in accordance with an illustrative embodiment;

FIG. 3 is a first page of a graphical user interface depicted in accordance with an illustrative embodiment;

FIGS. 4A and 4B is a second page of a graphical user interface depicted in accordance with an illustrative embodiment;

FIG. 5, a notification is depicted in accordance with an illustrative embodiment;

FIG. 6 is a flowchart of a process reminder and escalation in a workflow depicted in accordance with an illustrative embodiment

FIG. 7 is a flowchart of a process for amending the number of reminder dates depicted in accordance with an illustrative embodiment

FIG. 8 is a flowchart of a process for displaying the number of reminder dates depicted in accordance with an illustrative embodiment

FIG. 9 is a flowchart of a process for amending the number of reminders depicted in accordance with an illustrative embodiment; and

FIG. 10 is a block diagram of a data processing system depicted in accordance with an illustrative embodiment.

### DETAILED DESCRIPTION

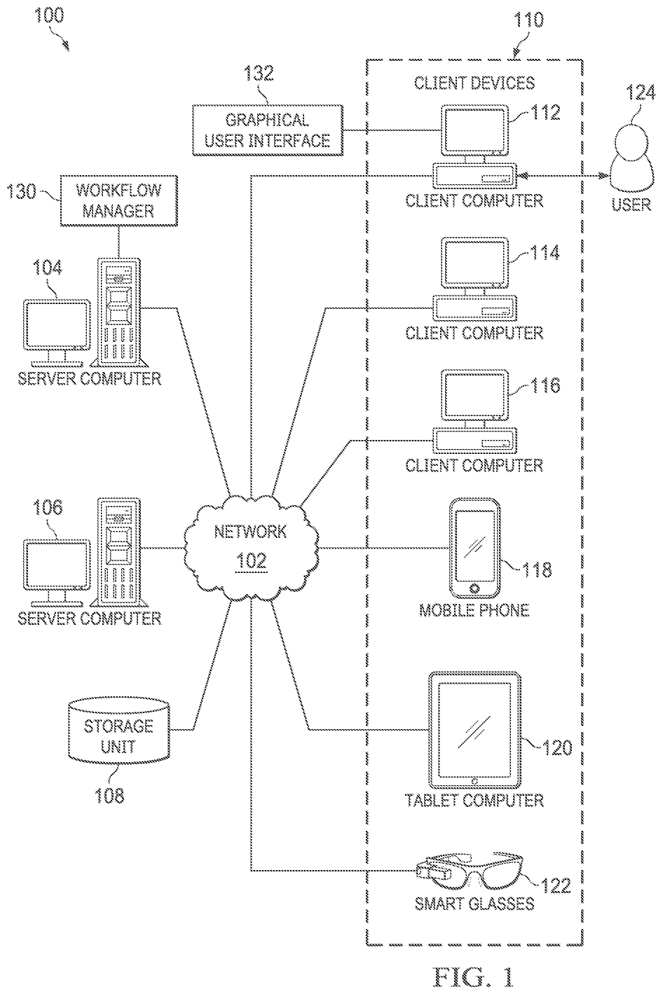

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage media and downloaded to a data processing system or other device for use. For example, the program code can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, a “number of,” when used with reference to items, means one or more items. For example, a “number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In the illustrative example, user can use graphical user interface 132 to interact with workflow manager 130. In the illustrative example, workflow manager 130 can generate graphical user interface 132 for setting up a workflow, including reminders and escalations, in response to receiving input from user 124 through graphical user interface 132.

In this illustrative example, workflow manager 130 can run on client computer 114 and can take the form of a system instance of the application. In another illustrative example, workflow manager 130 can be run in a remote location such as on server computer 104. In yet other illustrative examples, workflow manager 130 can be distributed in multiple locations within network data processing system 100. For example, workflow manager 130 can run on client computer 112 and on client computer 114 or on client computer 112 and server computer 104 depending on the particular implementation.

Workflow manager 130 can operate to handle the reminders and escalations automatically, where the user doesn't have to set up it from scratch. Instead, workflow manager 130 can provide a basic reminder framework which can be increased or decreased based on needs of the users. Graphical user interface 132 simplifies the set-up process, including both reminders and escalations.

graphical user interface 132 displays a timeline for each workflow milestone, giving clear visibility of the reminder dates and frequency, as well as when the milestone starts and when it ends. Workflow manager 130 can pick up start and end dates from any event, such the user does not necessarily need to separately enter that these dates into the workflow manager 130. Workflow manager 130 can be used as a plugin to use reminders for an event. Graphical user interface 132 may also provide a preview of a reminder and notification which will be sent to a receiver.

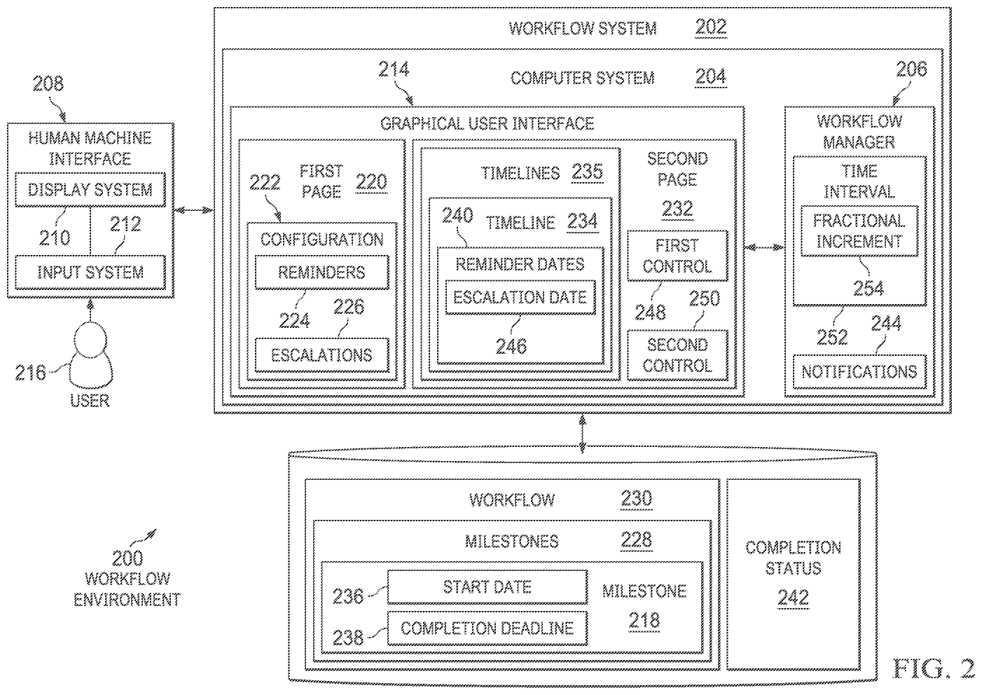

With reference now to FIG. 2, a block diagram of an application environment is depicted in accordance with an illustrative embodiment. In this illustrative example, application environment 200 includes components that can be implemented in hardware such as the hardware shown in network data processing system 100 in FIG. 1.

In this illustrative example, workflow management system 202 in application environment 200 can provide for reminder and escalation for workflow creation in a graphical user interface. As depicted, workflow management system 202 comprises computer system 204 and workflow manager 206. Workflow manager 206 runs in computer system 204. Workflow manager 206 can be implemented in software, hardware, firmware, or a combination thereof. When software is used, the operations performed by workflow manager 206 can be implemented in program code configured to run on hardware, such as a processor unit. When firmware is used, the operations performed by workflow manager 206 can be implemented in program code and data and stored in persistent memory to run on a processor unit. When hardware is employed, the hardware may include circuits that operate to perform the operations in workflow manager 206.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, human machine interface 208 comprises display system 210 and input system 212. Display system 210 is a physical hardware system and includes one or more display devices on which graphical user interface 214 can be displayed. The display devices can include at least one of a light emitting diode (LED) display, a liquid crystal display (LCD), an organic light emitting diode (OLED) display, a computer monitor, a projector, a flat panel display, a heads-up display (HUD), or some other suitable device that can output information for the visual presentation of information.

User 216 is a person that can interact with graphical user interface 214 through user input generated by input system 212 for computer system 204. Input system 212 is a physical hardware system and can be selected from at least one of a mouse, a keyboard, a trackball, a touchscreen, a stylus, a motion sensing input device, a gesture detection device, a cyber glove, or some other suitable type of input device.

In one or more illustrative embodiments, graphical user interface 214 solves problems of prior graphical user interface devices (GUIs), in the context of computerized trading, relating to speed, accuracy, and usability. Rather than reciting a mathematical algorithm, a fundamental economic or longstanding commercial practice, or a challenge in business, graphical user interface 214 improves on existing graphical user interface devices that do not have a pre-electronic workflow setup and monitoring analog. The embodiments of graphical user interface 214 provide significantly more than prior graphical user interface devices that merely allow for setting, displaying, and selecting data or information that is visible on a graphical user interface device. Instead, graphical user interface 214 utilizes a specific, structured interface directly related to a prescribed functionality that resolves a specific technical problem of handling the multiple tasks and their reminders and escalation timeline. configuring and validating reminders and escalation using prior systems without graphical user interface 214 often required a long-form entry, requiring lots of time and presenting a big challenge to the user.

Furthermore, the specific structure and concordant functionality of graphical user interface 214 distinguishes this system as compared to conventional computer implementations of known procedures. The function of graphical user interface 214 is not simply the generalized use of computer system 204 as a tool to conduct a known or obvious process. Instead, graphical user interface 214 provides an inventive concept that allows for automatic setup of electronic notifications, regularly reminding responsible employees and managers until a workflow milestone is completed. In general, graphical user interface 214 simplifies the process tedious for defining the date, frequency, and reminder messages for multiple tasks that may require different frequencies and settings for each workflow milestone. Rather than the routine or conventional use of computers or the Internet, graphical user interface 214 overcomes problems that are necessarily rooted in computer technology and that specifically arise in the realm of computer networks, resulting in an improvement to the capabilities of workflow management system 202.

In this illustrative example, human machine interface 208 can enable user 216 to interact with one or more computers or other types of computing devices in computer system 204. For example, these computing devices can be client devices such as client devices 110 in FIG. 1.

In this illustrative example, workflow manager 206 in computer system 204 is configured to provide reminder and escalation setup in a workflow using graphical user interface 214. In a first page 220 of the graphical user interface 214, workflow manager 206 receives configurations 222 for reminders 224 and escalations 226 for a set of milestones 228 in a workflow 230. Configurations 222 may indicate one or more of milestones 228 to which reminders 224 and escalations 226 should be applied, as well as when escalations 226 should begin.

In this illustrative example, a second page of the graphical user interface displays a timelines 234 for milestone 218 of the workflow 230. Each of the timelines 235 spans from a start date 236 to a completion deadline 238 for a respective one of milestones 228.

In this illustrative example, a second page of the graphical user interface displays a number of reminder dates 240 along each timeline 234, according to a respective configuration 222.

For example, workflow manager 206 may determine a time interval 252 between the start date 236 and the completion deadline 238. Workflow manager 206 may then determine reminder dates 240 as fractional increments 254 of the time interval 252. In one illustrative example, the fractional increments 254 corresponds to multiples of 10% fractional amounts of the time interval 252. The second page 232 of the graphical user interface 214 can then display the number of reminder dates 240 along the timeline 234 according to an associated fractional increment 254 of the time interval 252.

In one or more illustrative embodiments, reminder dates 240 substantially correspond to an associated fractional increment 254. The terms “approximately”, “about”, and “substantially” as used herein represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount. In one illustrative example, a date that substantially corresponds to an associated fractional increment is the date corresponding to a fractional amount that is closest to a fractional increment.

In one illustrative example, the second page 232 of the graphical user interface 214 displays a first control 248 and a second control 250 associated with each of timelines 235. The first control 248 is a control for increasing the number of reminder dates 240, while the second control 250 is a control for decreasing the number of reminder dates 240. Responsive to receiving an interaction with at least one of the first control or the second control, the number of reminder dates displayed along a corresponding timeline is amended, according to the interaction.

As used herein, a “control” is a graphical and/or functional element that can be reused across graphical user interface (GUI) applications and which the user can select and activate to get additional information. A control, in a graphical user interface, is an object on the screen that can be manipulated by the user to perform some action. A button is a common type of control.

In one illustrative example, reminders are amended along the corresponding timeline according to the nonsequential series. Reminder dates are amended to the timeline determining according to a nonsequential series of multiples of the fractional increments; wherein the nonsequential series is: a 90% fractional amount, a 70% fractional amount, a 50% fractional amount, an 80% fractional amount, a 60% fractional amount, a 40% fractional amount, and a 30% fractional amount.

In one illustrative example, workflow manager 206 monitors a completion status 242 for a milestone. Upon a reminder date, workflow manager 206 sends a notification if the milestone is not complete. Upon an escalation date, workflow manager 206 periodically sending notifications until the milestone is complete.

The periodic frequency may define how often notifications are sent. For example, upon escalation, workflow manager 206 may send notifications semi-hourly, hourly, bihourly, semi-daily, daily, bidaily, semiweekly, weekly, and biweekly, as well as other periodic frequencies for sending notifications.

In one illustrative example, one or more solutions are present that overcome a problem with handling the multiple tasks and their reminders and escalation timeline. As a result, one or more illustrative examples may Workflow manager 206 can operate to resolves a specific technical problem of configuring and validating reminders and escalation. In conjunction with graphical user interface 214, workflow manager 206 provides an inventive concept that allows for automatic setup of electronic notifications, regularly reminding responsible employees and managers until a workflow milestone is completed. Workflow manager 206 simplifies the process tedious for defining the date, frequency, and reminder messages for multiple tasks that may require different frequencies and setting for each workflow milestone. In this manner, workflow manager 206 overcomes problems that are necessarily rooted in computer technology and that specifically arise in the realm of computer networks, resulting in an improvement to the capabilities of workflow management system 202.

Computer system 204 can be configured to perform at least one of the steps, operations, or actions described in the different illustrative examples using software, hardware, firmware, or a combination thereof. As a result, computer system 204 operates as a special purpose computer system in workflow manager 206 in computer system 204. In particular, workflow manager 206 transforms computer system 204 into a special purpose computer system as compared to currently available general computer systems that do not have workflow manager 206. In this example, computer system 204 operates as a tool that can increase at least one of speed, accuracy, or usability of computer system 204.

The illustration of application environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

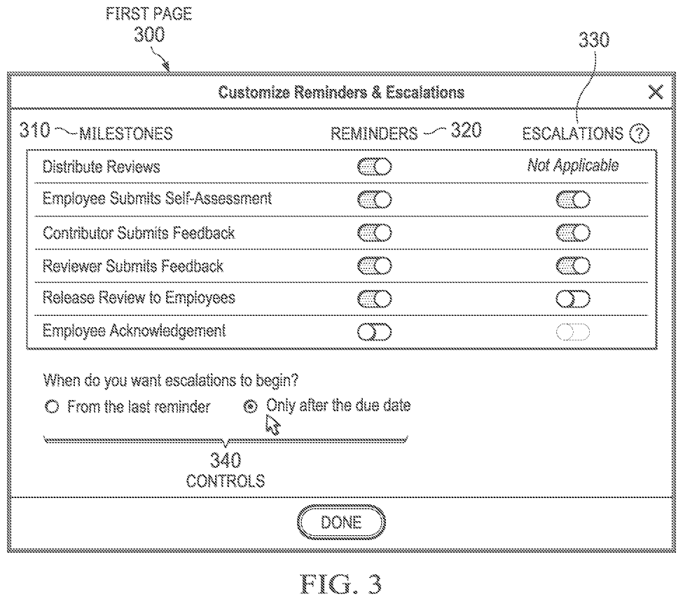

Turning now to FIGS. 3-5, illustrations of pages of a graphical user interface in a workflow system in accordance with an illustrative embodiment. With reference to FIG. 3, a first page of a graphical user interface is depicted in accordance with an illustrative embodiment. As depicted, first page 300 is an example one implementation for first page 220 of graphical user interface 214 in FIG. 2. First page 300 enables a user to submit configurations, such as configurations 222 of FIG. 2, for reminders and escalation.

First page 300 lists a number of milestones 310. For each of milestones 310, reminders can be selectively enabled through interactions with a corresponding one of controls 320. Escalations can be selectively enabled through interactions with a corresponding one of controls 330. Controls 340 enable selection of an escalation date.

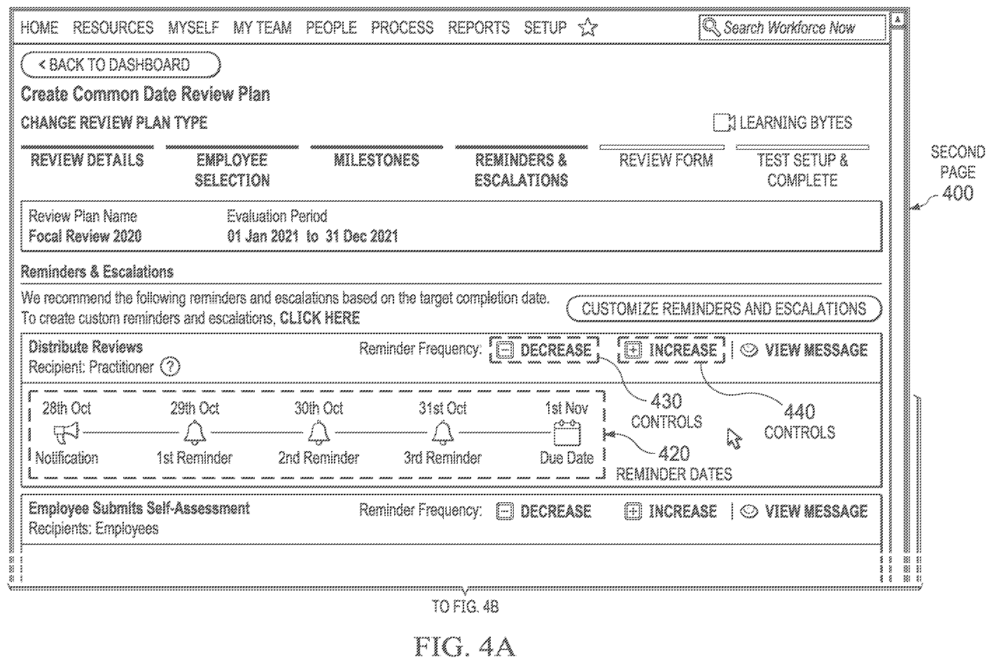

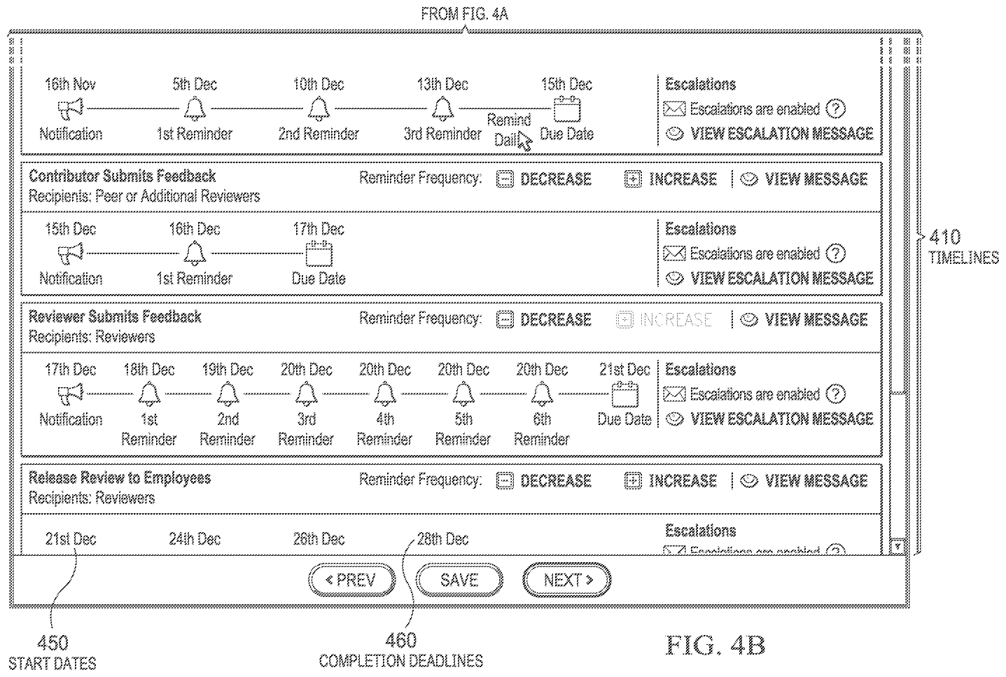

With reference to FIGS. 4A and 4B, a second page of a graphical user interface is depicted in accordance with an illustrative embodiment. As depicted, second page 400 is an example one implementation for second page 232 of graphical user interface 214 in FIG. 2.

Second page 400 displays a number of timelines 410. Each of timelines 410 corresponds to one of milestones 310, configured in first page 300 of FIG. 3.

A number of reminder dates 420 are displayed along each timelines 410. Reminder dates 420 can be selectively increased or decreased through interactions with a corresponding one of controls 430 and controls 440, respectively. In one illustrative example, reminder dates 420 are amended along the corresponding timeline according to a nonsequential series of multiples of fractional increments of the time duration between start dates 450 and completion deadlines 460.

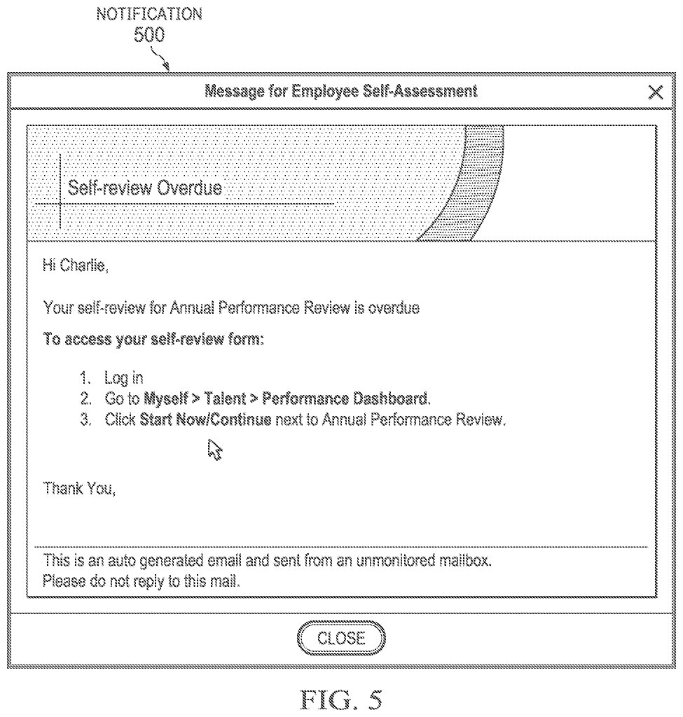

With reference to FIG. 5, a notification is depicted in accordance with an illustrative embodiment. As depicted, notification 500 is an example one implementation for notifications 244 in FIG. 2.

The illustrations of graphical user interface in FIGS. 3-5 are provided as one illustrative example of an implementation for reminder and escalation in a workflow and are not meant to limit the manner in which the reminder and escalation can be generated and presented in other illustrative examples.

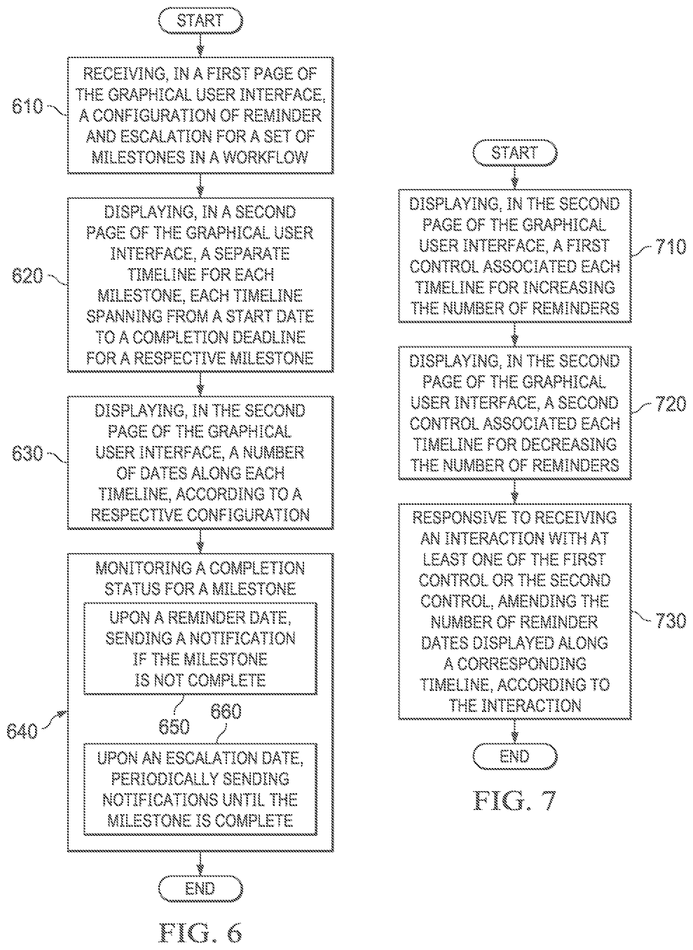

Turning next to FIG. 6, a flowchart of a process reminder and escalation in a workflow is depicted in accordance with an illustrative embodiment. The process in FIG. 6 can be implemented in hardware, software, or both. When implemented in software, the process can take the form of program code that is run by one or more processor units located in one or more hardware devices in one or more computer systems. For example, the process can be implemented in workflow manager 206 in computer system 204 in FIG. 2.

The process begins by receiving, in a first page of the graphical user interface, configurations of reminders and escalations for a set of milestones in a workflow (step 610). The process displays, in a second page of the graphical user interface, a separate timeline for each milestone, each timeline spanning from a start date to a completion deadline for a respective milestone (step 620). The process displays, in the second page of the graphical user interface, a number of reminder dates along each timeline, according to a respective configuration (step 630).

The process monitoring a completion status for a milestone (step 640). The monitoring includes, upon a reminder date, sending a notification if the milestone is not complete (step 640). The monitoring includes, upon an escalation date, sending notifications periodically until the milestone is complete (step 650). The process terminates thereafter.

With reference next to FIG. 7, a flowchart of a process for amending the number of reminder dates is depicted in accordance with an illustrative embodiment. The process in FIG. 7 can be implemented in conjunction with the process of FIG. 6.

The process displays, in the second page of the graphical user interface, a first control associated each timeline for increasing the number of reminder dates (step 710). The process displays, in the second page of the graphical user interface, a second control associated each timeline for decreasing the number of reminder dates (step 720). Responsive to receiving an interaction with at least one of the first control or the second control, the process amends the number of reminder dates displayed along a corresponding timeline, according to the interaction (step 730). The process terminates thereafter.

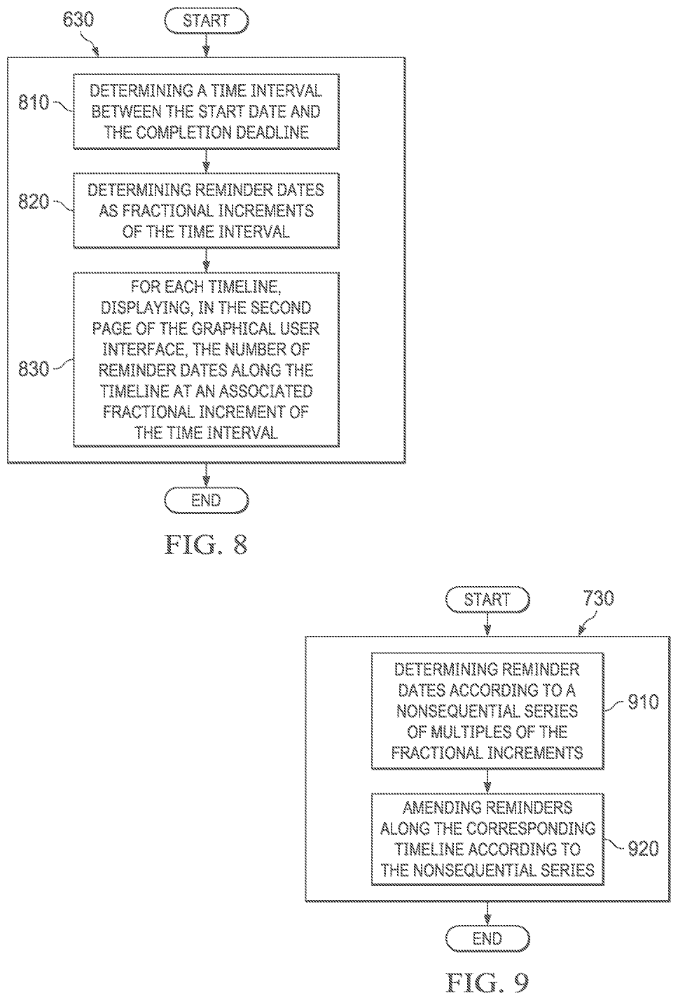

With reference next to FIG. 8, a flowchart of a process for displaying the number of reminder dates is depicted in accordance with an illustrative embodiment. The process in FIG. 8 is an example one implementation for step 630 in FIG. 6.

Continuing from steps 620, the process determines a time interval between the start date and the completion deadline (step 810). The process determines reminder dates as fractional increments of the time interval (step 820). For each timeline, the process displays, in the second page of the graphical user interface, the number of reminder dates along the timeline at an associated fractional increment of the time interval (step 830). Thereafter comma the process continues to step 640 of FIG. 6.

With reference next to FIG. 9, a flowchart of a process for amending the number of reminders is depicted in accordance with an illustrative embodiment. The process in FIG. 9 is an example one implementation for step 730 in FIG. 7.

Continuing from steps 720, the process determines reminder dates according to a nonsequential series of multiples of the fractional increments (step 910). The process amends reminders along the corresponding timeline according to the nonsequential series (step 920). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

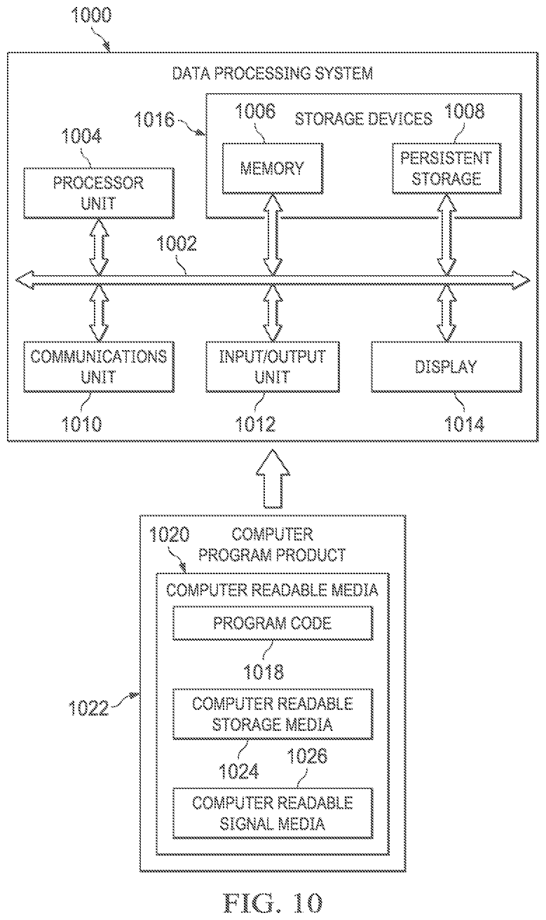

Turning now to FIG. 10, a block diagram of a data processing system is depicted in accordance with an illustrative embodiment. Data processing system 1000 can be used to implement server computer 104, server computer 106, client devices 110, in FIG. 1. Data processing system 1000 can also be used to implement computer system 204 in FIG. 2. In this illustrative example, data processing system 1000 includes communications framework 1002, which provides communications between processor unit 1004, memory 1006, persistent storage 1008, communications unit 1010, input/output (I/O) unit 1012, and display 1014. In this example, communications framework 1002 takes the form of a bus system.

Processor unit 1004 serves to execute instructions for software that can be loaded into memory 1006. Processor unit 1004 includes one or more processors. For example, processor unit 1004 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1004 can may be implemented using one or more heterogeneous processor systems in which a main processor is present with secondary processors on a single chip. As another illustrative example, processor unit 1004 can be a symmetric multi-processor system containing multiple processors of the same type on a single chip.

Memory 1006 and persistent storage 1008 are examples of storage devices 1016. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1016 may also be referred to as computer-readable storage devices in these illustrative examples. Memory 1006, in these examples, can be, for example, a random-access memory or any other suitable volatile or non-volatile storage device. Persistent storage 1008 may take various forms, depending on the particular implementation.

For example, persistent storage 1008 may contain one or more components or devices. For example, persistent storage 1008 can be a hard drive, a solid-state drive (SSD), a flash memory, a rewritable optical disk, a rewritable magnetic tape, or some combination of the above. The media used by persistent storage 1008 also can be removable. For example, a removable hard drive can be used for persistent storage 1008.

Communications unit 1010, in these illustrative examples, provides for communications with other data processing systems or devices. In these illustrative examples, communications unit 1010 is a network interface card.

Input/output unit 1012 allows for input and output of data with other devices that can be connected to data processing system 1000. For example, input/output unit 1012 may provide a connection for user input through at least one of a keyboard, a mouse, or some other suitable input device. Further, input/output unit 1012 may send output to a printer. Display 1014 provides a mechanism to display information to a user.

Instructions for at least one of the operating system, applications, or programs can be located in storage devices 1016, which are in communication with processor unit 1004 through communications framework 1002. The processes of the different embodiments can be performed by processor unit 1004 using computer-implemented instructions, which may be located in a memory, such as memory 1006.

These instructions are program instructions and are also referred are referred to as program code, computer usable program code, or computer-readable program code that can be read and executed by a processor in processor unit 1004. The program code in the different embodiments can be embodied on different physical or computer-readable storage media, such as memory 1006 or persistent storage 1008.

Program code 1018 is located in a functional form on computer-readable media 1020 that is selectively removable and can be loaded onto or transferred to data processing system 1000 for execution by processor unit 1004. Program code 1018 and computer-readable media 1020 form computer program product 1022 in these illustrative examples. In the illustrative example, computer-readable media 1020 is computer-readable storage media 1024.

In these illustrative examples, computer-readable storage media 1024 is a physical or tangible storage device used to store program code 1018 rather than a medium that propagates or transmits program code 1018. Computer-readable storage media 1024, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. The term “non-transitory” or “tangible”, as used herein, is a limitation of the medium itself (i.e., tangible, not a signal) as opposed to a limitation on data storage persistency (e.g., RAM vs. ROM).

Alternatively, program code 1018 can be transferred to data processing system 1000 using a computer-readable signal media. The computer-readable signal media are signals and can be, for example, a propagated data signal containing program code 1018. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1020” can be singular or plural. For example, program code 1018 can be located in computer-readable media 1020 in the form of a single storage device or system. In another example, program code 1018 can be located in computer-readable media 1020 that is distributed in multiple data processing systems. In other words, some instructions in program code 1018 can be located in one data processing system while other instructions in program code 1018 can be located in one data processing system. For example, a portion of program code 1018 can be located in computer-readable media 1020 in a server computer while another portion of program code 1018 can be located in computer-readable media 1020 located in a set of client computers.

The different components illustrated for data processing system 1000 are not meant to provide architectural limitations to the manner in which different embodiments can be implemented. In some illustrative examples, one or more of the components may be incorporated in or otherwise form a portion of, another component. For example, memory 1006, or portions thereof, may be incorporated in processor unit 1004 in some illustrative examples. The different illustrative embodiments can be implemented in a data processing system including components in addition to or in place of those illustrated for data processing system 1000. Other components shown in FIG. 10 can be varied from the illustrative examples shown. The different embodiments can be implemented using any hardware device or system capable of running program code 1018.

Thus, the illustrative embodiments of the present invention provide a computer-implemented method, computer system, and computer program product for reminder an escalation set up in a graphical user interface. In a first page of the graphical user interface, a computer system receives configurations of reminders and escalations for a set of milestones in a workflow. In a second page of the graphical user interface, the computer system displays a separate timeline for each milestone. Each timeline spans from a start date to a completion deadline for a respective milestone. In the second page of the graphical user interface, the computer system displays a number of reminder dates along each timeline, according to a respective configuration. The computer system monitors a completion status for a milestone. Upon a reminder date, the computer system sends a notification if the milestone is not complete. Upon an escalation date, the computer system sends notifications periodically until the milestone is complete.

The illustrative examples can be used to handle the reminders and escalations automatically, where the user doesn't have to set up it from scratch. Instead, The illustrative examples can provide a basic reminder framework which can be increased or decreased based on needs of the users. The illustrative examples simplify the set-up process, including both reminders and escalations

As a result, the illustrative examples can provide one or more solutions that overcome a problem with handling the multiple tasks and their reminders and escalation timeline. As a result, one or more illustrative examples may operate to resolves a specific technical problem of configuring and validating reminders and escalation. The described graphical user interface and workflow manager provide an inventive concept that allows for automatic setup of electronic notifications, simplifies the process tedious for defining the date, frequency, and reminder messages for multiple tasks that may require different frequencies and setting for each workflow milestone. In this manner, the illustrative examples overcome problems that are necessarily rooted in computer technology and that specifically arise in the realm of computer networks, resulting in an improvement to the capabilities of a workflow management system.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for reminder and escalation in a workflow for a graphical user interface, the method comprising:
receiving, by a computer system, in a first page of the graphical user interface, configurations of reminders and escalations for a set of milestones in the workflow;
displaying, by the computer system, in a second page of the graphical user interface, a separate timeline for each milestone, each timeline spanning from a start date to a completion deadline for a respective milestone; and
displaying, by the computer system, in the second page of the graphical user interface, a number of reminder dates along each timeline, according to a respective configuration.
monitoring, by the computer system, a completion status for a milestone, including:
upon a reminder date, sending, by the computer system, a notification if the milestone is not complete; and
upon an escalation date, periodically, by the computer system, sending notifications until the milestone is complete.

2. The method of claim 1, further comprising:
displaying, in the second page of the graphical user interface, a first control associated each timeline for increasing the number of reminder dates; and
displaying, in the second page of the graphical user interface, a second control associated each timeline for decreasing the number of reminder dates; and
responsive to receiving an interaction with at least one of the first control or the second control, amending the number of reminder dates displayed along a corresponding timeline, according to the interaction.

3. The method of claim 2, wherein displaying the number of dates further comprises:
determining a time interval between the start date and the completion deadline;
determining reminder dates as fractional increments of the time interval; and
for each timeline, displaying, in the second page of the graphical user interface, the number of reminder dates along the timeline at an associated fractional increment of the time interval.

4. The method of claim 3, wherein the fractional increments corresponds to multiples of 10% fractional amounts of the time interval.

5. The method of claim 3, wherein amending the number of reminders further comprises:
determining reminder dates according to a nonsequential series of multiples of the fractional increments; and
amending reminders along the corresponding timeline according to the nonsequential series.

6. The method of claim 5, wherein the nonsequential series is: a 90% fractional amount, a 70% fractional amount, a 50% fractional amount, an 80% fractional amount, a 60% fractional amount, a 40% fractional amount, and a 30% fractional amount.

7. The method of claim 3, wherein the escalation date corresponds to the completion deadline or to a 90% fractional amount of the time interval.

8. A computer system comprising:
a hardware processor;
a display system having a graphical user interface displayed thereon; and
a workflow manager, in communication with the hardware processor and the display system come out where any workflow manager is configured:
to receive, in a first page of the graphical user interface, configurations of reminders and escalations for a set of milestones in a workflow;
to display, in a second page of the graphical user interface, a separate timeline for each milestone, each timeline spanning from a start date to a completion deadline for a respective milestone;
to display, in the second page of the graphical user interface, a number of reminder dates along each timeline, according to a respective configuration;
to monitor a completion status for a milestone, including:
upon a reminder date, sending a notification if the milestone is not complete; and
upon an escalation date, periodically sending notifications until the milestone is complete.

9. The computer system of claim 8, where in the workflow manager is further configured:
to display, in the second page of the graphical user interface, a first control associated each timeline for increasing the number of reminder dates; and
to display, in the second page of the graphical user interface, a second control associated each timeline for decreasing the number of reminder dates; and
responsive to receiving an interaction with at least one of the first control or the second control, to amend the number of reminder dates displayed along a corresponding timeline, according to the interaction.

10. The computer system of claim 9, wherein in displaying the number of dates, the workflow manager is further configured:
to determine a time interval between the start date and the completion deadline;
to determine reminder dates as fractional increments of the time interval; and
for each timeline, to display, in the second page of the graphical user interface, the number of reminder dates along the timeline at an associated fractional increment of the time interval.

11. The computer system of claim 10, wherein the fractional increments corresponds to multiples of 10% fractional amounts of the time interval.

12. The computer system of claim 10, wherein in amending the number of reminders, the workflow manager is further configured:
to determine reminder dates according to a nonsequential series of multiples of the fractional increments; and
to amend reminders along the corresponding timeline according to the nonsequential series.

13. The computer system of claim 12, wherein the nonsequential series is: a 90% fractional amount, a 70% fractional amount, a 50% fractional amount, an 80% fractional amount, a 60% fractional amount, a 40% fractional amount, and a 30% fractional amount.

14. The computer system of claim 10, wherein the escalation date corresponds to the completion deadline or to a 90% fractional amount of the time interval.

15. A computer program product comprising:
a computer readable storage media; and
program code, stored on the computer readable storage media, for reminder in escalation in a workflow, the program code comprising:
program code, stored on the computer readable storage media, for receiving, in a first page of a graphical user interface, configurations of reminders and escalations for a set of milestones in a workflow;
program code, stored on the computer readable storage media, for displaying, in a second page of the graphical user interface, a separate timeline for each milestone, each timeline spanning from a start date to a completion deadline for a respective milestone;
program code, stored on the computer readable storage media, for displaying, in the second page of the graphical user interface, a number of reminder dates along each timeline, according to a respective configuration;
program code, stored on the computer readable storage media, for monitoring a completion status for a milestone, including:
upon a reminder date, sending a notification if the milestone is not complete; and
upon an escalation date, periodically sending notifications until the milestone is complete.

16. The computer program product of claim 15, further comprising:
program code, stored on the computer readable storage media, for displaying, in the second page of the graphical user interface, a first control associated each timeline for increasing the number of reminder dates; and
program code, stored on the computer readable storage media, for displaying, in the second page of the graphical user interface, a second control associated each timeline for decreasing the number of reminder dates; and
program code, stored on the computer readable storage media, for amending the number of reminder dates displayed along a corresponding timeline in response to receiving an interaction with at least one of the first control or the second control, according to the interaction.

17. The computer program product of claim 15, wherein the program code for displaying the number of dates further comprises:
program code, stored on the computer readable storage media, for determining a time interval between the start date and the completion deadline;
program code, stored on the computer readable storage media, for determining reminder dates as fractional increments of the time interval; and
program code, stored on the computer readable storage media, for displaying, for each timeline in the second page of the graphical user interface, the number of reminder dates along the timeline at an associated fractional increment of the time interval.

18. The computer program product of claim 17, wherein the fractional increments corresponds to multiples of 10% fractional amounts of the time interval.

19. The computer program product of claim 17, wherein the program code for amending the number of reminders further comprises:
program code, stored on the computer readable storage media, for determining reminder dates according to a nonsequential series of multiples of the fractional increments; and
program code, stored on the computer readable storage media, for amending reminders along the corresponding timeline according to the nonsequential series.

20. The computer program product of claim 19, wherein the nonsequential series is: a 90% fractional amount, a 70% fractional amount, a 50% fractional amount, an 80% fractional amount, a 60% fractional amount, a 40% fractional amount, and a 30% fractional amount.

21. The computer program product of claim 17, wherein the escalation date corresponds to the completion deadline or to a 90% fractional amount of the time interval.
